(19) United States
(12) Patent Application Publication
(10) Pub. No.: US 2022/0402025 A1
(43) Pub. Date: Dec. 22, 2022

(54) FINE PARTICLES AND FINE PARTICLE PRODUCTION METHOD

(71) Applicant: NISSHIN ENGINEERING INC., Tokyo (JP)

(72) Inventors: Shu WATANABE, Fujimino-city, Saitama (JP); Shiori SUEYASU, Fujimino-city, Saitama (JP); Keitaro NAKAMURA, Fujimino-city, Saitama (JP)

(21) Appl. No.: 17/777,459

(22) PCT Filed: Sep. 29, 2020
(86) PCT No.: PCT/JP2020/036764

§ 371 Date: May 17, 2022

(30) Foreign Application Priority Data
Nov. 18, 2019 (JP) 2019-208124

(51) Int. Cl. B22F 1/102; B82Y 30/00; B82Y 40/00; B22F 1/054; B22F 9/02

(52) U.S. Cl. CPC B22F 1/102; B82Y 30/00; B82Y 40/00; B22F 1/054; B22F 9/026; B22F 2301/10; B22F 2304/054

(57) ABSTRACT

Fine particles that can be sintered and grow to 100 nm or larger without oxidation even when retained at a baking temperature in an oxygen-containing atmosphere and that can suppress oxidation in a long-term preservation in the air or other oxygen-containing atmospheres, a method of producing the fine particles, and a method of producing fine particles that can suppress oxidation in a collecting process after the production of the fine particles. A fine particle production method for producing fine particles using feedstock powder by means of a gas-phase process includes a step of producing fine particle bodies by converting the feedstock powder into a mixture in a gas phase state using a gas-phase process and cooling the mixture in a gas phase state with a quenching gas containing an inert gas and a hydrocarbon gas having 4 or less carbon atoms, and a step of supplying an organic acid to the produced fine particle bodies.

### TECHNICAL FIELD

The present invention relates to nanosized fine particles having a particle size of 10 to 100 nm, particularly to fine particles whose oxidation is suppressed for a long period of time.

### BACKGROUND ART

At present, various types of fine particles are used in various applications. For instance, fine particles such as metal fine particles, oxide fine particles, nitride fine particles, and carbide fine particles have been used in electrical insulation materials for various electrical insulation parts, cutting tools, materials for machining tools, functional materials for sensors, sintered materials, electrode materials for fuel cells, and catalysts.

Meanwhile, the use of touch panels in which a display device such as a liquid crystal display device is combined with a touch panel for tablet computers, smartphones, and other devices, has become popular. As one touch panel, a touch panel having an electrode made of metal has been proposed.

For instance, a touch panel described in Patent Literature 1 has an electrode for touch panels that is constituted of conductive ink. In addition, a silver ink composition is described as an example of the conductive ink.

Aside from that, for touch panels required to have flexibility, substrates therein need to be flexible, so that the use of a general-purpose resin such as PET (polyethylene terephthalate) or PE (polyethylene) is required. When a general-purpose resin such as PET or PE is used for a substrate, since its heat resistance is lower than that of glass or ceramics, an electrode needs to be formed at lower temperature. For instance, Patent Literature 2 describes a copper fine particle material that is sintered by heating at temperature of not higher than 150° C. in a nitrogen atmosphere, has electric conductivity, and, even when exposed to air in an environment of 25° C. and relative humidity 60% for three months while being dispersed in ethanol, does not show a peak derived from copper oxide in an X-ray diffraction measurement of powder.

### CITATION LIST

### Patent Literature

Patent Literature 1: JP 2016-71629 A
Patent Literature 2: JP 2016-14181 A

### SUMMARY OF INVENTION

### Technical Problems

It is known that copper fine particles are easy to oxidize. For copper fine particles, it is necessary to take oxidation resistance into account, and long-term preservability of copper fine particles in air in a form of being dispersed in ethanol is considered in Patent Literature 2. However, in Patent Literature 2, copper fine particles are dispersed in ethanol and thus long-term preservability of copper fine particles alone is not taken into account. Accordingly, Patent Literature 2 does not provide fine particles that can suppress oxidation when the fine particles alone are preserved in the air or other oxygen-containing atmospheres on a monthly basis. At present, no fine particles can be stably preserved in the air or other oxygen-containing atmospheres at temperature of about 10 to 50° C. for a long period of time without oxidation.

The present invention has been made to solve the problem that may arise from the foregoing conventional art, and an object of the invention is to provide fine particles that can be sintered and grow to 100 nm or larger without oxidation even when retained at a baking temperature in an oxygen-containing atmosphere and that can suppress oxidation in a long-term preservation in the air or other oxygen-containing atmospheres, and a method of producing the fine particles. At the same time, another object is to provide a method of producing fine particles that can suppress oxidation in a collecting process after the production of the fine particles, which has been difficult to achieve.

### Solution to Problems

In order to attain the foregoing object, the present invention provides fine particles obtained by converting feedstock powder into a mixture in a gas phase state using a gas-phase process, cooling the mixture with a quenching gas containing an inert gas and a hydrocarbon gas having 4 or less carbon atoms to produce fine particle bodies, and supplying an organic acid to the fine particle bodies.

The feedstock powder is preferably copper powder.

The fine particles preferably have a particle size of 10 to 100 nm.

It is preferable that the fine particles have surface coating, and when the fine particles are baked in a nitrogen atmosphere with an oxygen concentration of 3 ppm, not less than 60 wt % of the surface coating is removed at 350° C.

The hydrocarbon gas having 4 or less carbon atoms is preferably methane gas.

The surface coating is preferably constituted of an organic substance generated by thermal decomposition of the hydrocarbon gas having 4 or less carbon atoms and thermal decomposition of an organic acid.

The organic acid preferably consists only of C, O and H.

The organic acid is preferably at least one of L-ascorbic acid, formic acid, glutaric acid, succinic acid, oxalic acid, DL-tartaric acid, lactose monohydrate, maltose monohydrate, maleic acid, D-mannite, citric acid, malic acid and malonic acid, and the organic acid is preferably citric acid.

The present invention provides a fine particle production method for producing fine particles using feedstock powder by means of a gas-phase process, the method comprising: a step of producing fine particle bodies by converting the feedstock powder into a mixture in a gas phase state using a gas-phase process and cooling the mixture in a gas phase state with a quenching gas containing an inert gas and a hydrocarbon gas having 4 or less carbon atoms, and a step of supplying the organic acid to the produced fine particle bodies in a temperature region in which the organic acid thermally decomposes.

The gas-phase process is preferably a thermal plasma process or a flame process.

The feedstock powder is preferably copper powder.

The hydrocarbon gas having 4 or less carbon atoms is preferably methane gas.

The organic acid preferably consists only of C, O and H.

The organic acid is preferably at least one of L-ascorbic acid, formic acid, glutaric acid, succinic acid, oxalic acid, DL-tartaric acid, lactose monohydrate, maltose monohydrate, maleic acid, D-mannite, citric acid, malic acid and malonic acid, and the organic acid is preferably citric acid.

### Advantageous Effects of Invention

The fine particles of the invention can be sintered and grow to 100 nm or larger without oxidation even when retained at a baking temperature in an oxygen-containing atmosphere and that can suppress oxidation in a long-term preservation in the air or other oxygen-containing atmospheres.

In addition, the fine particles of the invention can suppress oxidation in a collecting process after the production of the fine particles, which has been difficult to achieve.

Moreover, the method of producing fine particles of the invention makes it possible to obtain the above-described fine particles.

### BRIEF DESCRIPTION OF DRAWINGS

FIG. 1 is a schematic view showing an example of a fine particle production apparatus that is used in a method of producing fine particles according to the invention.

FIG. 2 is a graph showing an analysis result of the crystal structure of the fine particles of the invention as obtained by X-ray diffractometry.

FIG. 3 is a graph showing an analysis result of the crystal structure of fine particles of Conventional Example 1 as obtained by X-ray diffractometry.

FIG. 4 is a graph showing the percentages of removed surface coating on the fine particles of the invention and that on the fine particles of Conventional Example 1 in a nitrogen atmosphere with an oxygen concentration of 3 ppm.

FIG. 5 is a schematic view showing the fine particles of the invention.

FIG. 6 is a schematic view showing the fine particles of the invention having been retained in a nitrogen atmosphere with an oxygen concentration of 3 ppm at temperature of 400° C. for 1 hour.

### DESCRIPTION OF EMBODIMENTS

The method of producing fine particles and the fine particles according to the invention are described below in detail with reference to preferred embodiments shown in the accompanying drawings.

Hereinbelow, an example of the method of producing fine particles according to the invention is described.

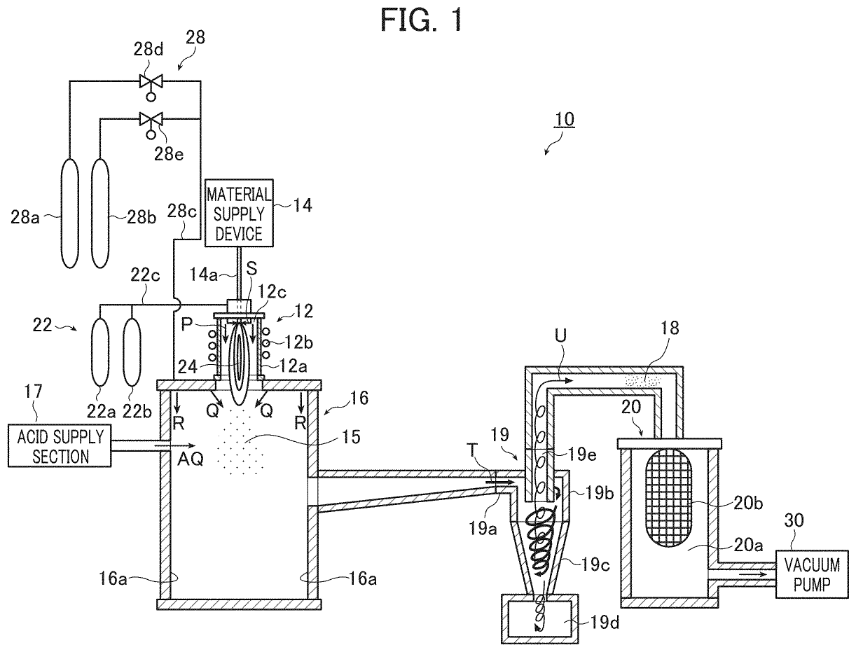

FIG. 1 is a schematic view showing an example of the fine particle production apparatus that is used in the method of producing fine particles according to the invention. A fine particle production apparatus 10 (hereinafter referred to simply as “production apparatus 10”) shown in FIG. 1 is used to produce fine particles.

The fine particles are not particularly limited in type as long as they are fine particles, and the production apparatus 10 can produce fine particles other than metal fine particles, namely, such fine particles as oxide fine particles, nitride fine particles, carbide fine particles, oxynitride fine particles, and resin fine particles by changing the composition of the feedstock.

The production apparatus 10 includes a plasma torch 12 generating thermal plasma, a material supply device 14 supplying feedstock powder of fine particles into the plasma torch 12, a chamber 16 serving as a cooling tank for use in producing primary fine particles 15, an acid supply section 17, a cyclone 19 removing, from the produced primary fine particles 15, coarse particles having a particle size equal to or larger than an arbitrarily specified particle size, and a collecting section 20 collecting secondary fine particles 18 having a desired particle size as obtained by classification by the cyclone 19. The primary fine particles 15 before an organic acid is supplied are fine particle bodies in the middle of the production process of the fine particles of the invention, and the secondary fine particles 18 are equivalent to the fine particles of the invention. The primary fine particles 15 and the secondary fine particles 18 are constituted of, for example, copper.

Various devices in, for example, JP 2007-138287 A may be used for the material supply device 14, the chamber 16, the cyclone 19, and the collecting section 20.

In the embodiment, for example, copper powder is used as the feedstock powder in the production of the fine particles. The average particle size of copper powder is appropriately set to allow easy evaporation of the powder in a thermal plasma flame. The average particle size of copper powder is measured by a laser diffraction method and is, for example, not larger than 100 μm, preferably not larger than 10 μm, and more preferably not larger than 5 μm. The feedstock is not limited to copper, but other metal powder than copper powder can be used, and alloy powder can also be used.

The powder transformed into the fine particles of the invention can be stably preserved in the air or other oxygen-containing atmospheres at temperature of 10 to 50° C. for as long a period as about one month without oxidation. Therefore, metals except gold (Au), silver (Ag) and other noble metals are preferably made into the fine particles. A metal or an alloy that oxidizes in the air or other oxygen-containing atmospheres at temperature of 10 to 50° C. is suitable for the fine particles, and copper that easily oxidizes is particularly suitable.

The plasma torch 12 is constituted of a quartz tube 12a and a coil 12b for high frequency oscillation surrounding the outside of the quartz tube. A supply tube 14a to be described later which is for supplying feedstock powder of the fine particles into the plasma torch 12 is provided on the top of the plasma torch 12 at the central part thereof. A plasma gas supply port 12c is formed in the peripheral portion of the supply tube 14a (on the same circumference). The plasma gas supply port 12c is in a ring shape. To the coil 12b for high frequency oscillation, a power source (not shown) that generates a high frequency voltage is connected. When a high frequency voltage is applied to the coil 12b for high frequency oscillation, a thermal plasma flame 24 is generated.

A plasma gas supply source 22 is configured to supply plasma gas into the plasma torch 12 and for instance has a first gas supply section 22a and a second gas supply section 22b. The first gas supply section 22a and the second gas supply section 22b are connected to the plasma gas supply port 12c through piping 22c. Although not shown, the first gas supply section 22a and the second gas supply section 22b are each provided with a supply amount adjuster such as a valve for adjusting the supply amount. Plasma gas is supplied from the plasma gas supply source 22 into the plasma torch 12 through the plasma gas supply port 12c of ring shape in the direction indicated by arrow P and the direction indicated by arrow S.

For example, mixed gas of hydrogen gas and argon gas is used as plasma gas. In this case, hydrogen gas is stored in the first gas supply section 22a, while argon gas is stored in the second gas supply section 22b. Hydrogen gas is supplied from the first gas supply section 22a of the plasma gas supply source 22 and argon gas is supplied from the second gas supply section 22b thereof into the plasma torch 12 in the direction indicated by arrow P and the direction indicated by arrow S after passing through the piping 22c and then the plasma gas supply port 12c. Argon gas may be solely supplied in the direction indicated by arrow P.

When a high frequency voltage is applied to the coil 12b for high frequency oscillation, a thermal plasma flame 24 is generated in the plasma torch 12. The feedstock powder (not shown) is evaporated by the thermal plasma flame 24 and transformed into a mixture in a gas phase state.

It is necessary for the thermal plasma flame 24 to have a higher temperature than the boiling point of the feedstock powder. A higher temperature of the thermal plasma flame 24 is more preferred because the feedstock powder is more easily transformed into a gas phase state; however, there is no particular limitation on the temperature. For instance, the thermal plasma flame 24 may have temperature of 6,000° C., and in theory, the temperature is deemed to reach around 10,000° C.

The ambient pressure inside the plasma torch 12 is preferably up to atmospheric pressure. For the atmosphere at a pressure up to atmospheric pressure, the pressure is not particularly limited and is, for example, in the range of 0.5 to 100 kPa.

The periphery of the quartz tube 12a is surrounded by a concentrically formed tube (not shown), and cooling water is circulated between this tube and the quartz tube 12a to cool the quartz tube 12a with the water, thereby preventing the quartz tube 12a from having an excessively high temperature due to the thermal plasma flame 24 generated in the plasma torch 12.

The material supply device 14 is connected to the top of the plasma torch 12 through the supply tube 14a. The material supply device 14 is configured to supply the feedstock in a powdery form into the thermal plasma flame 24 in the plasma torch 12, for example.

For instance, as described above, the device disclosed in JP 2007-138287 A may be used as the material supply device 14 that supplies the feedstock, e.g., copper powder in a powdery form. In this case, the material supply device 14 includes, for example, a storage tank (not shown) storing the feedstock powder, a screw feeder (not shown) transporting the feedstock powder in a fixed amount, a dispersion section (not shown) dispersing the feedstock powder transported by the screw feeder to convert it into the form of primary particles before the feedstock powder is finally sprayed, and a carrier gas supply source (not shown).

Together with carrier gas to which push-out pressure is applied from the carrier gas supply source, the feedstock powder is supplied into the thermal plasma flame 24 in the plasma torch 12 through the supply tube 14a.

The configuration of the material supply device 14 is not particularly limited as long as the device can prevent the feedstock powder from agglomerating, thus making it possible to spray the feedstock powder in the plasma torch 12 with the dispersed state maintained. Inert gas such as argon gas is used as the carrier gas, for example. The flow rate of the carrier gas can be controlled using, for instance, a flowmeter such as a float type flowmeter. The flow rate value of the carrier gas is indicated by a reading on the flowmeter.

The chamber 16 is provided below and adjacent to the plasma torch 12, and a gas supply device 28 is connected to the chamber 16. The primary fine particles 15 of copper, for example, are produced in the chamber 16. The chamber 16 serves as a cooling tank.

The gas supply device 28 is configured to supply cooling gas into the chamber 16. The thermal plasma flame 24 evaporates the feedstock powder and converts it into a mixture in a gas phase state, and the gas supply device 28 supplies a cooling gas (quenching gas) containing an inert gas to the mixture.

The gas supply device 28 has a first gas supply source 28a, a second gas supply source 28b, and piping 28c. The gas supply device 28 further includes a pressure application apparatus (not shown) such as a compressor or a blower which applies push-out pressure to the cooling gas to be supplied into the chamber 16.

The gas supply device 28 is also provided with a pressure control valve 28d which controls an amount of gas supplied from the first gas supply source 28a and a pressure control valve 28e which controls an amount of gas supplied from the second gas supply source 28b. For example, the first gas supply source 28a stores argon gas, while the second gas supply source 28b stores methane gas. In this case, the cooling gas is mixed gas of argon gas and methane gas.

The gas supply device 28 supplies the mixed gas of argon gas and methane gas as the cooling gas at, for example, 45 degrees in the direction of arrow Q toward a tail portion of the thermal plasma flame 24, i.e., the end of the thermal plasma flame 24 on the opposite side from the plasma gas supply port 12c, that is, a terminating portion of the thermal plasma flame 24, and also supplies the cooling gas from above to below along an inner wall 16a of the chamber 16, that is, in the direction of arrow R shown in FIG. 1.

The cooling gas supplied from the gas supply device 28 into the chamber 16 quenches the copper powder having been evaporated and transformed to a mixture in a gas phase state by the thermal plasma flame 24, thereby obtaining the primary fine particles 15 of copper. Besides, the cooling gas has additional functions such as contribution to classification of the primary fine particles 15 in the cyclone 19. The cooling gas is, for instance, mixed gas of argon gas and methane gas.

When the primary fine particles 15 of copper having just been produced collide with each other to form agglomerates, this causes nonuniform particle size, resulting in lower quality. However, dilution of the primary fine particles 15 with the mixed gas supplied as the cooling gas in the direction of arrow Q toward the tail portion (terminating portion) of the thermal plasma flame prevents the fine particles from colliding with each other to agglomerate together.

In addition, the mixed gas supplied as the cooling gas in the direction of arrow R prevents the primary fine particles 15 from adhering to the inner wall 16a of the chamber 16 in the process of collecting the primary fine particles 15, whereby the yield of the produced primary fine particles 15 is improved.

While the mixed gas of argon gas and methane gas was used as the cooling gas (quenching gas), this is not the sole case. Argon gas is an example of inert gas, while methane gas (CH₄) is an example of hydrocarbon gas having 4 or less carbon atoms.

In the cooling gas (quenching gas), not only argon gas but also nitrogen gas or the like can be used. In addition, not only methane gas but also any hydrocarbon gas having 4 or less carbon atoms can be used. Hence, in the cooling gas (quenching gas), paraffinic hydrocarbon gases such as ethane (C₂H₆), propane (C₃H₆), and butane (C₄H₁₀), and olefinic hydrocarbon gases such as ethylene (C₂H₄), propylene (C₃H₆), and butylene (C₄H₈) can be used.

The acid supply section 17 is configured to supply, in the chamber 16, an organic acid in a temperature region in which the organic acid thermally decomposes, to the primary fine particles 15 (fine particle bodies) obtained through quenching by the cooling gas (quenching gas). An organic acid supplied to a higher temperature region than the decomposition temperature of the organic acid thermally decomposes, and the organic acid is deposited, on surfaces of the primary fine particles 15 produced by quenching the thermal plasma having a temperature of about 10,000° C., as an organic substance containing hydrocarbon (CnHm) and either a carboxyl group (—COOH) or a hydroxyl group (—OH) that provides hydrophilicity and acidity. As a result, fine particles whose surfaces are covered by an organic compound having oxygen are obtained.

Thermal decomposition of an organic acid means decomposition of an organic acid into smaller molecules constituting the organic acid by thermal energy in an oxygen-free atmosphere, and the decomposed substances may include water (H₂O), carbon dioxide (CO₂), or the like. Thermal decomposition of an organic acid is different from decomposition of an organic acid into water (H₂O) and carbon dioxide (CO₂). In addition, an oxygen-free atmosphere in this description means an atmosphere that does not contain sufficient oxygen for H (hydrogen) and C (carbon) constituting the organic acid to all become water (H₂O) or carbon dioxide (CO₂).

The acid supply section 17 may have any configuration as long as it can provide an organic acid to the primary fine particles 15. For instance, it suffices if an aqueous organic acid solution is used, and the acid supply section 17 sprays the aqueous organic acid solution into the chamber 16.

The acid supply section 17 includes a container (not shown) storing an aqueous organic acid solution (not shown) and a spray gas supply section (not shown) for converting the aqueous organic acid solution in the container into droplets. The spray gas supply section converts an aqueous solution into droplets using spray gas, and an aqueous organic acid solution AQ transformed into droplets is supplied to the primary fine particles 15 of copper in the chamber 16.

The acid supply section 17 supplies an organic acid in the chamber 16 to the primary fine particles 15 (fine particle bodies) at temperature higher than the temperature at which a thermal reaction or endothermic reaction occurs in the thermogravimeter-differential thermal analysis (TG-DTA) of the organic acid and lower than 1,000° C. The temperature region higher than the temperature at which a thermal reaction or endothermic reaction occurs in the thermogravimeter-differential thermal analysis (TG-DTA) of the organic acid and lower than 1,000° C. as described above is the temperature region in which the organic acid thermally decomposes.

When an aqueous citric acid solution is used, for example, the acid supply section 17 is required to supply the solution in a region in which citric acid after water evaporation in the chamber 16 is to have temperature higher than 150° C., i.e., the endothermic reaction starting temperature in the TG-DTA, in consideration of latent heat necessary for evaporation of water contained in the aqueous citric acid solution. This temperature is, for example, 300° C.

For the aqueous organic acid solution, pure water is used as the solvent, for instance. The organic acid is soluble in water, preferably has a low boiling point, and is preferably constituted only of C, O and H. As the organic acid, use can be made of, for instance, L-ascorbic acid (C₆H₈O₆), formic acid (CH₂O₂), glutaric acid (C₅H₈O₄), succinic acid (C₄H₆O₄), oxalic acid (C₂H₂O₄), DL-tartaric acid (C₄H₆O₆), lactose monohydrate, maltose monohydrate, maleic acid (C₄H₄O₄), D-mannite (C₆H₁₄O₆), citric acid (C₆H₆O₇), malic acid (C₄H₆O₅) and malonic acid (C₃H₄O₄). Use of at least one of the foregoing organic acids is preferred.

For the spray gas used to convert the aqueous organic acid solution into droplets, argon gas is adopted for instance, but the spray gas is not limited to argon gas and may be inert gas such as nitrogen gas.

As shown in FIG. 1, the cyclone 19 is provided to the chamber 16 to classify the primary fine particles 15 of copper having been supplied with the organic acid, based on a desired particle size. The cyclone 19 includes an inlet tube 19a which supplies the primary fine particles 15 from the chamber 16, a cylindrical outer tube 19b connected to the inlet tube 19a and positioned at an upper portion of the cyclone 19, a truncated conical part 19c continuing downward from the bottom of the outer tube 19b and having a gradually decreasing diameter, a coarse particle collecting chamber 19d connected to the bottom of the truncated conical part 19c for collecting coarse particles having a particle size equal to or larger than the above-mentioned desired particle size, and an inner tube 19e connected to the collecting section 20 to be detailed later and projecting from the outer tube 19b.

A gas stream containing the primary fine particles 15 is blown from the inlet tube 19a of the cyclone 19 to flow along the inner peripheral wall of the outer tube 19b, and accordingly, this gas stream flows in the direction from the inner peripheral wall of the outer tube 19b toward the truncated conical part 19c as indicated by arrow T in FIG. 1, thus forming a downward swirling stream.

When the downward swirling stream is inverted to an upward stream, coarse particles cannot follow the upward stream due to the balance between the centrifugal force and drag, fall down along the lateral surface of the truncated conical part 19c and are collected in the coarse particle collecting chamber 19d. Fine particles having been affected by the drag more than the centrifugal force are discharged to the outside of the cyclone 19 through the inner tube 19e along with the upward stream on the inner wall of the truncated conical part 19c.

The apparatus is configured such that a negative pressure (suction force) is exerted from the collecting section 20 to be detailed later through the inner tube 19e. Due to the negative pressure (suction force), the fine particles separated from the swirling gas stream are sucked as indicated by arrow U and sent to the collecting section 20 through the inner tube 19e.

On the extension of the inner tube 19e which is an outlet for the gas stream in the cyclone 19, the collecting section 20 for collecting the secondary fine particles (fine particles) 18 having a desired particle size on the order of nanometers is provided. The collecting section 20 includes a collecting chamber 20a, a filter 20b provided in the collecting chamber 20a, and a vacuum pump 30 connected through a pipe provided at a lower portion of the collecting chamber 20a. The fine particles delivered from the cyclone 19 are sucked by the vacuum pump 30 to be introduced into the collecting chamber 20a, and remain on the surface of the filter 20b and are then collected.

It should be noted that the number of cyclones used in the production apparatus 10 is not limited to one and may be two or more.

Next, one example of the method of producing fine particles using the production apparatus 10 above is described below.

First, for example, copper powder having an average particle size of not more than 5 μm is charged into the material supply device 14 as the feedstock powder of the fine particles.

For example, argon gas and hydrogen gas are used as the plasma gas, and a high frequency voltage is applied to the coil 12b for high frequency oscillation to generate the thermal plasma flame 24 in the plasma torch 12.

Further, for instance, argon gas and methane gas are supplied as the cooling gas in the direction of arrow Q from the gas supply device 28 to the tail portion of the thermal plasma flame 24, i.e., the terminating portion of the thermal plasma flame 24. At that time, argon gas is supplied as the cooling gas in the direction of arrow R.

Next, the copper powder is transported with gas, e.g., argon gas used as the carrier gas and supplied to the thermal plasma flame 24 in the plasma torch 12 through the supply tube 14a. The copper powder supplied is evaporated in the thermal plasma flame 24 to be transformed into a gas phase state and is quenched with the cooling gas, thus producing the primary fine particles 15 (fine particle bodies) of copper. Further, the acid supply section 17 sprays the aqueous organic acid solution in a droplet form to the primary fine particles 15 of copper.

Then, the primary fine particles 15 of copper thus obtained in the chamber 16 are blown in through the inlet tube 19a of the cyclone 19 together with a gas stream along the inner peripheral wall of the outer tube 19b, and accordingly, this gas stream flows along the inner peripheral wall of the outer tube 19b as indicated by arrow T in FIG. 1, thus forming a swirling stream which goes downward. When the downward swirling stream is inverted to an upward stream, coarse particles cannot follow the upward stream due to the balance between the centrifugal force and drag, fall down along the lateral surface of the truncated conical part 19c and are collected in the coarse particle collecting chamber 19d. Fine particles having been affected by the drag more than the centrifugal force are discharged along the inner wall of the truncated conical part 19c to the outside of the cyclone 19 together with the upward stream on the inner wall.

Due to the negative pressure (suction force) applied by the vacuum pump 30 through the collecting section 20, the discharged secondary fine particles (fine particles) 18 are sucked in the direction indicated by arrow U in FIG. 1 and sent to the collecting section 20 through the inner tube 19e to be collected on the filter 20b of the collecting section 20. The internal pressure of the cyclone 19 at this time is preferably equal to or lower than the atmospheric pressure. For the particle size of the secondary fine particles (fine particles) 18, an arbitrary particle size on the order of nanometers is specified according to the intended purpose.

In the invention, while the primary fine particles of copper are formed using a thermal plasma flame, the primary fine particles of copper may be formed by another gas-phase process. Thus, the method of producing the primary fine particles of copper is not limited to the one using a thermal plasma flame as long as it is a gas-phase process, and may alternatively be one using a flame process, for example. Here, the method of producing the primary fine particles using a thermal plasma flame is called thermal plasma process.

The flame process herein is a method of synthesizing fine particles by using a flame as the heat source and, for instance, putting copper-containing feedstock through the flame. In the flame process, for example, the copper-containing feedstock is supplied to a flame, and then cooling gas is supplied to the flame to decrease the flame temperature and thereby suppress the growth of copper particles, thus obtaining the primary fine particles 15 of copper. In addition, an organic acid is supplied to the primary fine particles 15 to thereby produce copper fine particles.

In the flame process, for the cooling gas and the organic acid, the same gases and acids as those mentioned for the thermal plasma process described above can also be used.

Next, the fine particles are described.

The fine particles have a particle size of 10 to 100 nm and have surface coating. The surface coating is constituted of an organic compound having oxygen.

The particle size of 10 to 100 nm of the fine particles stated above is the size in the state where the particles have not been exposed to temperature higher than 100° C., that is, in the state where there is no thermal history. The above particle size of the fine particles is preferably 10 to 90 nm.

The fine particles can suppress oxidation even when preserved in the air or other oxygen-containing atmospheres at temperature of about 10 to 50° C. for as long a period as about one month. This point will be described later.

The fine particles of the invention are those called nanoparticles, and the particle size stated above is the average particle size measured using the BET method. The fine particles of the invention are produced by, for instance, the production method described above and obtained in a particulate form.

The fine particles of the invention are not present in a dispersed form in a solvent or the like but are present alone. Therefore, there is no particular limitation on the combination with a solvent and the like, and the degree of freedom is high in selection of a solvent. As described above, when the fine particles are preserved in an oxygen-containing atmosphere, the fine particles are present alone, not in a dispersed form in ethanol or another liquid.

The copper fine particles of the invention can be sintered and grow to 100 nm or larger without oxidation even when retained at a baking temperature in an oxygen-containing atmosphere, and the copper fine particles can suppress oxidation in a long-term preservation in the air or other oxygen-containing atmospheres. In addition, the fine particles of the invention can suppress oxidation in a collecting process after the production of the fine particles, which has been difficult to achieve.

The surface coating is constituted of an organic substance that is generated by thermal decomposition of hydrocarbon gas having 4 or less carbon atoms and thermal decomposition of an organic acid and that contains hydrocarbon (CnHm) and either a carboxyl group (—COOH) or a hydroxyl group (—OH) which provides hydrophilicity and acidity. For example, the surface coating is constituted of an organic substance generated by thermal decomposition of methane gas and thermal decomposition of citric acid. That is, the surface coating is constituted of an organic compound having oxygen as described above.

The surface condition of the fine particles can be examined using, for instance, a Fourier transform infrared spectrometer (FT-IR).

The fine particles of the invention can be produced using the production apparatus 10 described above and using methane gas and citric acid as hydrocarbon gas having 4 or less carbon atoms and the organic acid, respectively.

Specifically, the production conditions of the fine particles are as follows. Plasma gas: argon gas (200 liter/min), hydrogen gas (5 liter/min); carrier gas: argon gas (5 liter/min); quenching gas: argon gas (150 liter/min), methane gas (0.5 liter/min); internal pressure: 40 kPa.

For the citric acid, pure water is used as the solvent to form an aqueous solution containing citric acid (citric acid concentration: 30 W/W %), which is to be sprayed to the primary fine particles of copper with the spray gas. The spray gas is argon gas.

Fine particles of Conventional Example 1 can be produced by the same production method as that of the fine particles of the invention except that the cooling gas is argon gas.

As described above, the fine particles of the invention can suppress oxidation even when preserved in the air or other oxygen-containing atmospheres at temperature of about 10 to 50° C. for as long a period as about one month. Since long-term preservation in the air is possible, the fine particles do not require an environment with a reduced amount of oxygen and can be easily preserved for a long period of time. On the other hand, when preserved in the same environment as that of the fine particles of the invention, the fine particles of Conventional Example 1 shortly oxidize, compared to the fine particles of the invention, and are not suitable for a long-term preservation. Accordingly, conventional fine particles need a preservation environment with a reduced amount of oxygen, or a preservation term thereof needs to be shortened.

Preservation of the fine particles is specifically described.

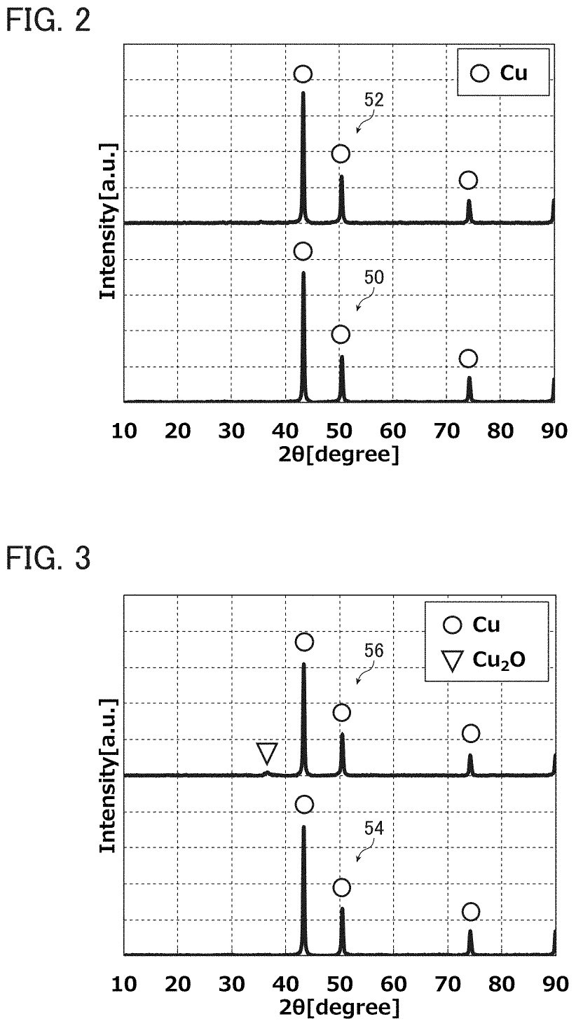

FIG. 2 is a graph showing an analysis result of the crystal structure of the fine particles of the invention as obtained by X-ray diffractometry. FIG. 2 shows the crystal structure analysis result as obtained by X-ray diffractometry immediately after the production. FIG. 2 also shows the crystal structure analysis result as obtained by X-ray diffractometry after preservation in an oxygen-containing atmosphere at temperature of 25° C. for 1.5 months.

FIG. 3 is a graph showing an analysis result of the crystal structure of the fine particles of Conventional Example 1 as obtained by X-ray diffractometry. FIG. 3 shows the crystal structure analysis result as obtained by X-ray diffractometry immediately after the production. FIG. 3 also shows the crystal structure analysis result as obtained by X-ray diffractometry after preservation in an oxygen-containing atmosphere at temperature of 25° C. for two weeks.

Note that the term “immediately after the production” stated above means that the fine particles are preserved in the air at temperature of not higher than 50° C. for not more than one day after the production, and there is no thermal history.

In FIG. 2, numeral 50 represents the X-ray diffraction pattern of the fine particles of the invention immediately after the production, and numeral 52 represents the X-ray diffraction pattern of the fine particles of the invention after preservation in an oxygen-containing atmosphere for 1.5 months.

In FIG. 3, numeral 54 represents the X-ray diffraction pattern of the fine particles of Conventional Example 1 immediately after the production, and numeral 56 represents the fine particles of Conventional Example 1 after preservation in an oxygen-containing atmosphere for two weeks.

As is apparent from FIGS. 2 and 3, immediately after the production, the fine particles of the invention (X-ray diffraction pattern 50) and of Conventional Example 1 (X-ray diffraction pattern 54) have peaks at the same position.

The X-ray diffraction pattern 52 of the fine particles of the invention does not change even after an elapse of 1.5 months as in FIG. 2. In other words, the fine particles of the invention can suppress oxidation even when preserved in an oxygen-containing atmosphere at temperature of about 25° C. for a long period of time.

On the other hand, the X-ray diffraction pattern 56 of the fine particles of Conventional Example 1 after an elapse of two weeks showed a Cu₂O diffraction peak as in FIG. 3. The fine particles of Conventional Example 1 cannot suppress oxidation when preserved in an oxygen-containing atmosphere at temperature of about 25° C. for a long period of time.

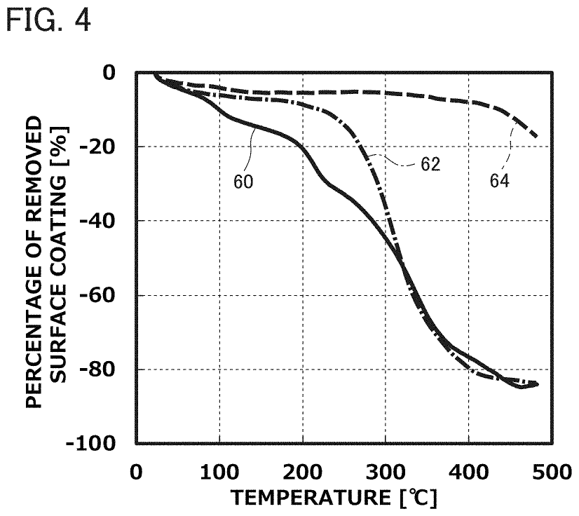

FIG. 4 is a graph showing the percentages of removed surface coating on the fine particles (copper fine particles) of the invention and copper fine particles of Conventional Examples 1 and 2 in a nitrogen atmosphere with an oxygen concentration of 3 ppm. FIG. 4 is provided based on the results obtained with a thermogravimeter-differential thermal analyzer (TG-DTA).

Numeral 60 in FIG. 4 represents the fine particles (copper fine particles) of the invention, while numeral 62 and numeral 64 represent the copper fine particles of Conventional Example 1 and Conventional Example 2, respectively. Conventional Example 2 corresponds to the product of the invention with differences of the use of methane gas as the quenching gas and no supply of citric acid in its production.

In production of copper fine particles, when only argon gas is used as the quenching gas and an aqueous solution containing citric acid is not sprayed, mere production of copper fine particles is possible, but as soon as the collecting section 20 is opened to collect the produced copper fine particles, the copper fine particles oxidize due to oxygen in the air and are oxidized into copper oxide, being difficult to be collected as copper fine particles.

As shown in FIG. 4, when the fine particles of the invention are baked in a nitrogen atmosphere with an oxygen concentration of 3 ppm, not less than 60 wt % of the surface coating is removed at 350° C. In the fine particles of the invention, the removal percentage of the surface coating is 84.8% (maximum value). The removal percentages of the surface coating are 83.7% (maximum value) and 17.4% (maximum value) in Conventional Example 1 and Conventional Example 2, respectively. The higher removal percentage of the surface coating means that the fine particles are more easily sintered. In Conventional Example 2, the removal percentage of the surface coating is low, and it is expected to be difficult for the fine particles to be sintered.

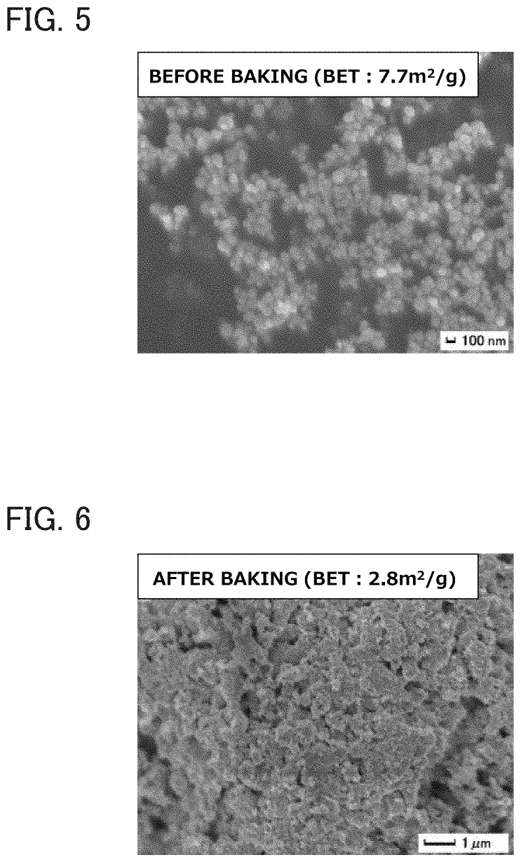

FIG. 5 is a schematic view showing the fine particles of the invention, and FIG. 6 is a schematic view showing the fine particles of the invention having been retained in a nitrogen atmosphere with an oxygen concentration of 3 ppm at temperature of 400° C. for one hour. FIG. 5 shows the fine particles before baking, and the particle size is 87 nm. FIG. 6 shows the fine particles having been retained at temperature of 400° C. for one hour, and the particle size is 242 nm. It is confirmed that the particle size becomes larger after retention at temperature of 400° C. for one hour.

As described above, the fine particles of the invention have a larger particle size after retention at temperature of 400° C. for one hour, and the fine particles alone can be favorably used for conductors such as conductive wires. Meanwhile, the invention is not limited to this application. For instance, when a conductor such as a conductive wire is produced, the fine particles may be mixed with copper particles with a particle size on the order of micrometers to serve as a sintering aid for the copper particles. Alternatively, the fine particles may be utilized for, in addition to conductors such as conductive wires, those required to have electrical conductivity, and for example, may be used in bonding between semiconductor devices, between a semiconductor device and any of various electronic devices, and between a semiconductor device and a wiring layer.

The present invention is basically as configured above. While the fine particle production method and fine particles according to the invention are described above in detail, the invention is by no means limited to the foregoing embodiments and it should be understood that various improvements and modifications are possible without departing from the scope and spirit of the invention.

### REFERENCE SIGNS LIST

10 fine particle production apparatus
12 plasma torch
14 material supply device
15 primary fine particle
16 chamber
17 acid supply section
18 secondary fine particle
19 cyclone
20 collecting section
22 plasma gas supply source
22a first gas supply section
22b second gas supply section
24 thermal plasma flame
28 gas supply device
28a first gas supply source
30 vacuum pump
AQ aqueous solution

1-16. (canceled)

17. Fine particles obtained by converting feedstock powder into a mixture in a gas phase state using a gas-phase process, cooling the mixture with a quenching gas containing an inert gas and a hydrocarbon gas having 4 or less carbon atoms to produce fine particle bodies, and supplying an organic acid to the fine particle bodies.

18. The fine particles according to claim 17, wherein the feedstock powder is copper powder.

19. The fine particles according to claim 17, wherein the fine particles have a particle size of 10 to 100 nm.

20. The fine particles according to claim 17, wherein the fine particles have surface coating, and when the fine particles are baked in a nitrogen atmosphere with an oxygen concentration of 3 ppm, not less than 60 mass % of the surface coating is removed at 350° C.

21. The fine particles according to claim 18, wherein the fine particles have surface coating, and when the fine particles are baked in a nitrogen atmosphere with an oxygen concentration of 3 ppm, not less than 60 mass % of the surface coating is removed at 350° C.

22. The fine particles according to claim 20, wherein the surface coating is constituted of an organic substance generated by thermal decomposition of the hydrocarbon gas having 4 or less carbon atoms and thermal decomposition of the organic acid.

23. The fine particles according to claim 17, wherein the hydrocarbon gas having 4 or less carbon atoms is methane gas.

24. The fine particles according to claim 17, wherein the organic acid consists only of C, O and H.

25. The fine particles according to claim 17, wherein the organic acid is at least one of L-ascorbic acid, formic acid, glutaric acid, succinic acid, oxalic acid, DL-tartaric acid, lactose monohydrate, maltose monohydrate, maleic acid, D-mannite, citric acid, malic acid and malonic acid.

26. The fine particles according to claim 17, wherein the organic acid is citric acid.

27. A fine particle production method for producing fine particles using feedstock powder by means of a gas-phase process, the method comprising:
a step of producing fine particle bodies by converting the feedstock powder into a mixture in a gas phase state using the gas-phase process and cooling the mixture in a gas phase state with a quenching gas containing an inert gas and a hydrocarbon gas having 4 or less carbon atoms, and
a step of supplying the organic acid to the produced fine particle bodies in a temperature region in which the organic acid thermally decomposes.

28. The fine particle production method according to claim 27, wherein the gas-phase process is a thermal plasma process or a flame process.

29. The fine particle production method according to claim 27, wherein the feedstock powder is copper powder.

30. The fine particle production method according to claim 27, wherein the hydrocarbon gas having 4 or less carbon atoms is methane gas.

31. The fine particle production method according to claim 27, wherein the organic acid consists only of C, O and H.

32. The fine particle production method according to claim 27, wherein the organic acid is at least one of L-ascorbic acid, formic acid, glutaric acid, succinic acid, oxalic acid, DL-tartaric acid, lactose monohydrate, maltose monohydrate, maleic acid, D-mannite, citric acid, malic acid and malonic acid.

33. The fine particle production method according to claim 31, wherein the organic acid is at least one of L-ascorbic acid, formic acid, glutaric acid, succinic acid, oxalic acid, DL-tartaric acid, lactose monohydrate, maltose monohydrate, maleic acid, D-mannite, citric acid, malic acid and malonic acid.

34. The fine particle production method according to claim 27, wherein the organic acid is citric acid.

35. The fine particle production method according to claim 31, wherein the organic acid is citric acid.
